(19) United States
(12) Patent Application Publication
(10) Pub. No.: US 2005/0131745 A1
(43) Pub. Date: Jun. 16, 2005

(54) Barcode based time tracking method and system

(75) Inventors: Eric Keller, Conestogo (CA); Steven Funston, Petersburg (CA); Wayne Pau, Waterloo (CA)

Correspondence Address: BERESKIN AND PARR, 40 KING STREET WEST, BOX 401, TORONTO, ON, M5H 3Y2, CA

(73) Assignee: WiredTime.com Inc., Kitchener (CA)

(21) Appl. No.: 10/733,309

(22) Filed: Dec. 12, 2003

(51) Int. Cl. H04L 9/00; G06F 17/60; H04K 1/00

(52) U.S. Cl. 705/7

(57) ABSTRACT

The invention relates to a method, system and computer program product for tracking time spent at a location by a person. The invention involves (a) providing at least one machine-readable location identification code at the location to provide location information for the location; (b) providing the person with a reader for reading the at least one machine-readable location identification code at the location; (c) on arrival of the person at the location, reading a first-read machine-readable location identification code in the at least one machine-readable location identification code using the reader and determining departure time based on when the first-read machine-readable location identification code is read; (d) on departure of the person from the location, reading a last-read machine-readable location identification code in the at last one machine-readable location identification code using the reader and determining an arrival time based on when the last-read machine-readable location identification code is read; and, (e) recording service information data comprising the arrival time and the departure time.

### FIELD OF THE INVENTION

The invention relates generally to worker tracking and information systems, and more particularly relates to a method and system for tracking the amount of time spent by workers at remote locations on a range of specified tasks.

### BACKGROUND OF THE INVENTION

Many jobs must be performed for customers at the customer's location, rather than at the location of the company performing the jobs. For example, jobs such as grounds maintenance, snow clearing and security must be performed at locations that are remote from the company providing the workers for these jobs. In this context, it is often difficult to monitor how much time workers are actually spending at a particular location and on a particular job. This information is important for a number of reasons. First, it is important that jobs are adequately performed. Second, it may be important in determining worker remuneration.

In addition, this information may be essential for certain customers. For example, it may be essential to a particular business to know whether snow has been cleared or other work has been done. This is not only true at the time the work is to be performed, but may also be very important months or years after the work has been completed. That is, many snow clearing companies have had their insurance premiums go up dramatically as a result of slip-and-fall type cases. The lawyers representing the plaintiffs in these cases typically allege that the snow clearing contractor failed to adequately clear the snow and ice at the location at which the fall occurred. The lawyers subpoena witnesses from these contractors. The witnesses then produce the records that workers were actually at these sites at these specific times, but the lawyers then bring this evidence into question by having experts testify that it is not at all unusual for workers to misrepresent the amount of time they spend at a location. Thus, there is an increasing need to accurately and verifiably track the time workers spend at particular locations.

### SUMMARY OF THE INVENTION

In accordance with an aspect of the present invention, there is provided a method of tracking time spent at a location by a person. The method comprises (a) providing at least one machine-readable location identification code at the location to provide location information for the location; (b) providing the person with a reader for reading the at least one machine-readable location identification code at the location; (c) on arrival of the person at the location, reading a first-read machine-readable location identification code in the at least one machine-readable location identification code using the reader and determining departure time based on when the first-read machine-readable location identification code is read; (d) on departure of the person from the location, reading a last-read machine-readable location identification code in the at last one machine-readable location identification code using the reader and determining an arrival time based on when the last-read machine-readable location identification code is read; and, (e) recording service information data comprising the arrival time and the departure time.

In accordance with a second aspect of the present invention, there is provided a system for tracking time spent at a location by a person. The system comprises (a) at least one machine-readable location identification code provided at the location to provide location information for the location; (b) a mobile reader for reading the at least one machine-readable location identification code at the location; (c) a time keeper for determining an arrival time when a first-read machine-readable location identification code in the at least one machine-readable location identification code is read and a departure time when a last-read machine-readable location identification code in the at least one machine-readable location identification code is read; and (d) a storage medium for recording service information data comprising the arrival time and the departure time.

In accordance with a third aspect of the present invention, there is provided a computer program product for use on a computer system to track the time spent at a location by a person. The computer program product comprises a recording medium; and means recorded on the medium for instructing the computer system to perform the steps of (a) receiving service information data from a person, the service information data comprising at least one pair of matching entries, the at least one pair of matching entries comprising an arrival entry and a departure entry, the arrival entry comprising a first-read location code and the departure entry comprising a second-read location code, (b) determining the location based on the first-read location code and the second-read location code; (c) determining an arrival time from the arrival entry; and, (d) determining a departure time from the departure entry.

### BRIEF DESCRIPTION OF THE DRAWINGS

These and other advantages of the instant invention will be more fully and completely understood in conjunction with the following detailed description of the preferred aspects of the present invention with reference to the following drawings in which:

FIG. 1, in a schematic view, illustrates a real-time mobile phone-based scanning and tracking system in accordance with a first aspect of the invention;

FIG. 2, in a block diagram, illustrates a memory scanner-based scanning and tracking system in accordance with a second aspect of the invention;

FIG. 3, in a block diagram, illustrates a server component of the systems of FIGS. 1 and 2;

FIG. 4, is a site outline for an application program installed on the server of FIG. 3 in accordance with an aspect of the invention;

FIG. 5 is a screen capture of a login module of the application program of FIG. 4;

FIG. 6 is a screen capture of a default menu of the application program of FIG. 4;

FIG. 7 is a screen capture of a customer display module of the application program of FIG. 4;

FIG. 8 is a screen capture of an add customer window module of the application program of FIG. 4;

FIG. 9 is a screen capture of an edit customer window module of the application program of FIG. 4;

FIG. 10 is a screen capture of a site display module of the application program of FIG. 4;

FIG. 11 is a screen capture of an add site window of the application program of FIG. 4;

FIG. 12 is a screen capture of an edit site window module of the application program of FIG. 4;

FIG. 13 is a screen capture of a task display module of the application program of FIG. 4;

FIG. 14 is a screen capture of an add task window module of the application program of FIG. 4;

FIG. 15 is a screen capture of an edit task window module of the application program of FIG. 4;

FIG. 16 is a task barcode creation module of the application program of FIG. 4;

FIG. 17 is a screen capture of an order display module of the application program of FIG. 4;

FIG. 18 is a screen capture of an add worker window module of the application program of FIG. 4;

FIG. 19 is a screen capture of a edit worker information window module of the application program of FIG. 4;

FIG. 20 is a screen capture of a filter report window module of the application program of FIG. 4;

FIG. 21 is a screen capture of a report display window module of the application program of FIG. 4;

FIG. 22 is a screen capture of a filtered report display window of the application program of FIG. 4;

FIG. 23 is a screen capture of a filtered report display window module of the application program of FIG. 4 that has been filtered based on a date; and,

FIG. 24 is a screen capture of a filtered report display window module of the application program of FIG. 4 that has been filtered by worker.

### DETAILED DESCRIPTION OF PREFERRED ASPECTS OF THE INVENTION

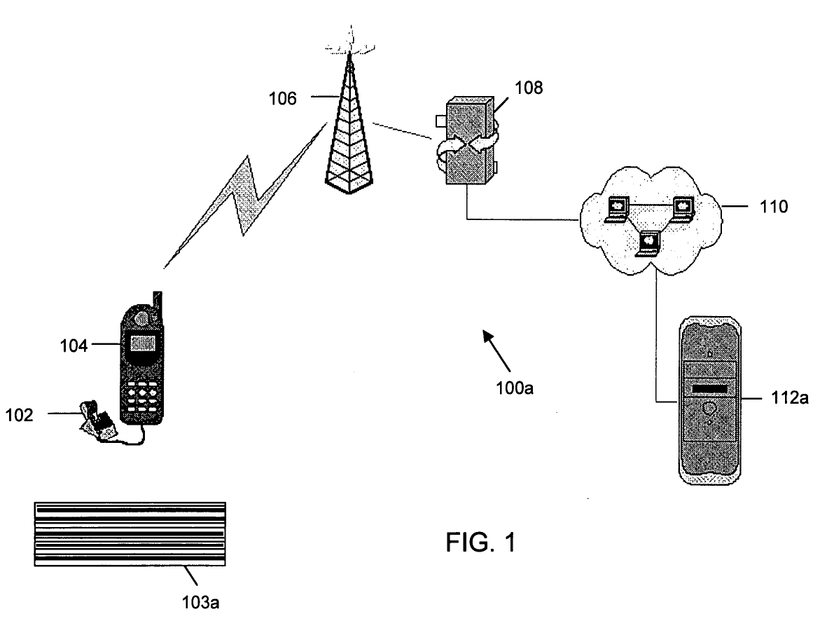

Referring to FIG. 1, there is illustrated in a schematic view, a real-time mobile phone-based tracking and scanning system in accordance with a first preferred aspect of the invention. As shown, the system 100a comprises a mobile phone 104 linked to a barcode scanner 102. In operation, a worker would arrive at a remote location with the mobile phone 104 and barcode scanner 102. The worker would then turn on the mobile phone and load the appropriate scanning system. Different barcodes are installed at different locations. A barcode 103a installed at the location can then be scanned by pointing the scanner 102 at the barcode 103a. A beam of red light will then project from the barcode scanner 102 to the barcode 103a and will disappear when the barcode 103a has been successfully scanned or read by the barcode scanner 112.

After reading the barcode 103a, the barcode scanner 102 has a token provided by the barcode scan that identifies the location at which the barcode 103a is installed. A second token identifying the worker must also be entered into either the barcode scanner 102 or the mobile phone 104. This may be done by any number of different means. For example, the worker may be identified by a barcode, which the worker scans in to provide the second token that identifies them. Alternatively, the mobile phone 104 or barcode scanner 102 may automatically designate a worker as that barcode scanner 102 or mobile phone 104 is always in the possession of the worker. Alternatively, the worker may enter a unique personal identification number into the barcode scanner 102 or mobile phone 104 at the beginning of his or her shift to self-authenticate.

The barcode scanner 102 communicates the barcode scan to the mobile phone 104. Preferably, the time at which the barcode 103a was scanned (the scan time) is either determined by a time keeper in the barcode scanner 102, and communicated to the mobile phone 104, or is determined by internal clock of the mobile phone 104 after the barcode scan is received. In the latter case, the barcode scan is communicated to the mobile phone 104 immediately after being taken. Mobile phone 104 will then send the barcode scan to the server 112a via mobile phone network 106, wireless application protocol (WAP) gateway 108 and Internet 110. The barcode scan taken from barcode 103a, which designates the location at which it is installed, will be used by server 112a to determine the location at which the worker is working. Optionally, server 112a will record the time at which this barcode 103a was received.

By this means, real-time tracking of a worker at a location can be provided. That is, the worker would scan the barcode 103a on first arriving at the location. The barcode scan and this first scan time are then sent to the server 112a as described above. At the server, the barcode scan and the first scan time are recorded. When the worker is about to leave the location, the barcode 103a will be scanned again, and again sent to the server 112a together with a second scan time. At this point, the server will record the first scan time as an arrival time, and the second scan time as a departure time, for that worker at that location.

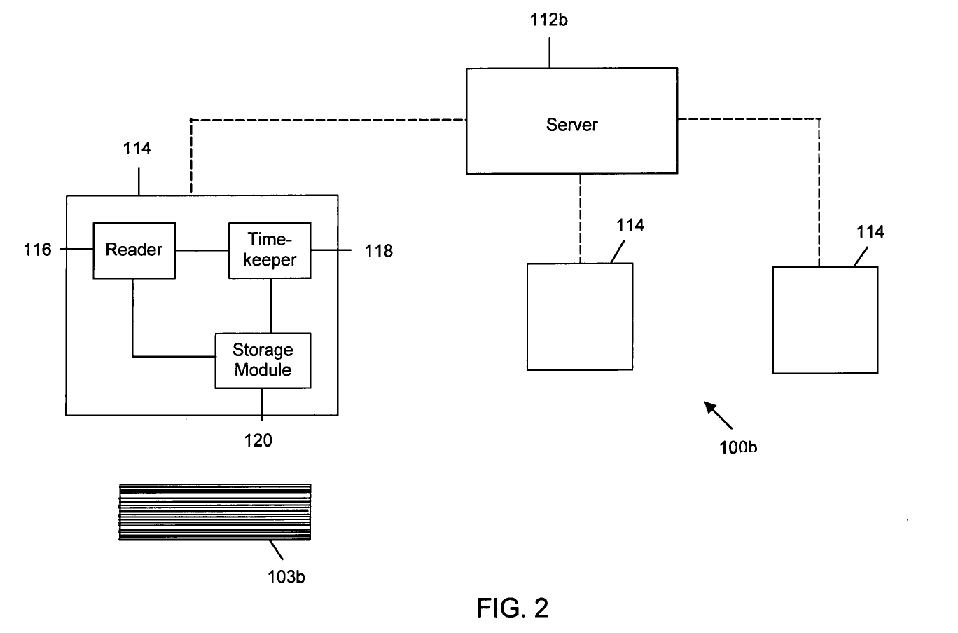

Referring to FIG. 2, there is illustrated a memory scanner tracking and scanning system 100b in accordance with a second aspect of the present invention. The system 100b is designed to meet the needs of customers by tracking worker data on a day-to-day basis for reporting purposes, when real-time access to barcode data is not required. The system 100b includes a server 112b, which is analogous to server 112a. Each worker carries a memory scanner 114 with him or her in the field. The memory scanner 114 includes a reader 116, timekeeper 118 and storage module 120. Similar to the system 100a, the worker on arriving at a site will scan a barcode 103b using the reader 116. This barcode data, together with time-of-scan data (a time and date stamp) provided by the timekeeper 118 will then be stored in storage module 120. At the end of a shift, this stored barcode data can be uploaded to a terminal, and sent over the Internet to the central server 112b, where the data is stored for the use of the tracking system. As mentioned above, the system 100b is useful in contexts in which real-time tracking of workers is not required. Further, it may also be useful in environments where cell phone operation is compromised.

Similar to system 100a described above, the worker must also provide a token to the memory scanner 114 to self-authenticate. This may readily be done by scanning in a barcode corresponding to the worker. Alternatively, other means, such as those described above, may be used.

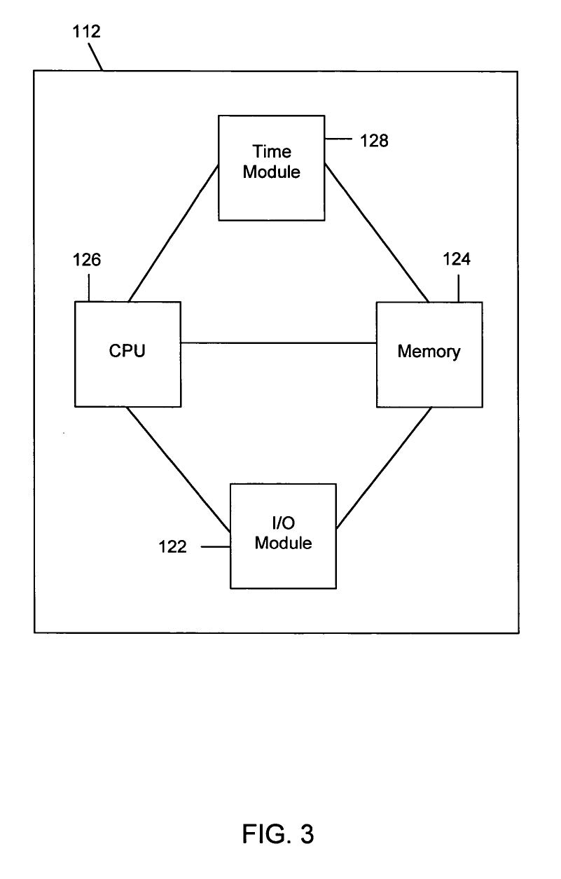

Referring to FIG. 3, there is illustrated in a block diagram, the server 112, shown as server 112a and server 112b in FIGS. 1 and 2 respectively. As shown, the server 112 includes an input and output module 122 for, in the case of system 100a, receiving barcode and scan time data from the mobile phone 104, via mobile phone network 106, WAP gateway 108 and Internet 110. Barcode information is then stored in memory 124. In the case of the system 100b, the scan time is determined by the timekeeper 118 in the memory scanner 114 when the barcode 103b is scanned using reader 116. This information is eventually uploaded and sent over the Internet to the central server 112b as described above. In both cases, the time can then be compared with the time that the barcode data arrived at the server 112 as determined by time module 128.

This barcode information, as well as information regarding the worker who sent the barcode information, can then be correlated with other worker information or information regarding the location from which the barcode data was sent and tasks to be performed at that location. Then, the CPU 126 can be configured to conduct searches of this data and to filter this data to produce (1) shift reports regarding all of the locations at which a particular worker has worked, (2) site reports regarding all the time and workers who have spent time at a particular location, or (3) time reports that set out all of the locations at which workers have worked, and the times they have spent at such locations, during a specified time interval.

According to a preferred embodiment of the invention, multiple barcodes may be provided at each location. Each barcode designates a different task to be performed at that location. According to this aspect of the invention, the worker would scan a first task barcode on arriving at a location. All of the task barcodes at that location would have the same location identification code. Thus, on scanning the first task barcode, the worker would also scan the location identification code. In addition, the worker would also scan associated task identification information for the first task to be performed.

Upon completing the first task, the worker would preferably scan the first task barcode again, thereby indicating that the first task had been completed. In the case of the system 100a of FIG. 1, this barcode information would be transmitted to the server 112a as described above, thereby enabling a record to be kept of when the worker started the first task at the first location and when the worker finished the first task at the first location. Optionally, instead of the worker scanning the first barcode a second time, the worker could, on completion of the first task, simply scan the second task barcode to indicate that the worker was commencing the second task and had completed the first task. According to this aspect of the invention, the completion time of the first task would be same as the start time of the second task.

By this means, a record can be kept not only of the time spent by a particular worker at a particular location, but also of the time spent by a worker on a particular task at a particular location. As described above, in the case of system 100a, this information is transmitted to server 112a as it is read. In the case of system 100b, this information is securely stored in the memory scanner 114 and is uploaded to a terminal and sent over the Internet to the central server 112b upon completion of the shift. As will be described in more detail below, this enables reports to be printed that not only indicate how much time was spent at the particular location, but also how much time was spent at particular tasks at particular locations.

Preferably, where multiple barcodes are provided at each location to designate the different tasks to be performed at that location, each such barcode will express the same location code identifying that location. Alternatively, however, each of these barcodes may identify task information only. However, as information regarding where each task is to be performed is stored on the server 112, when a task code read from each barcode is received by the server 112, the location can be determined. Thus, even the task code on its own can't constitute a location identification code.

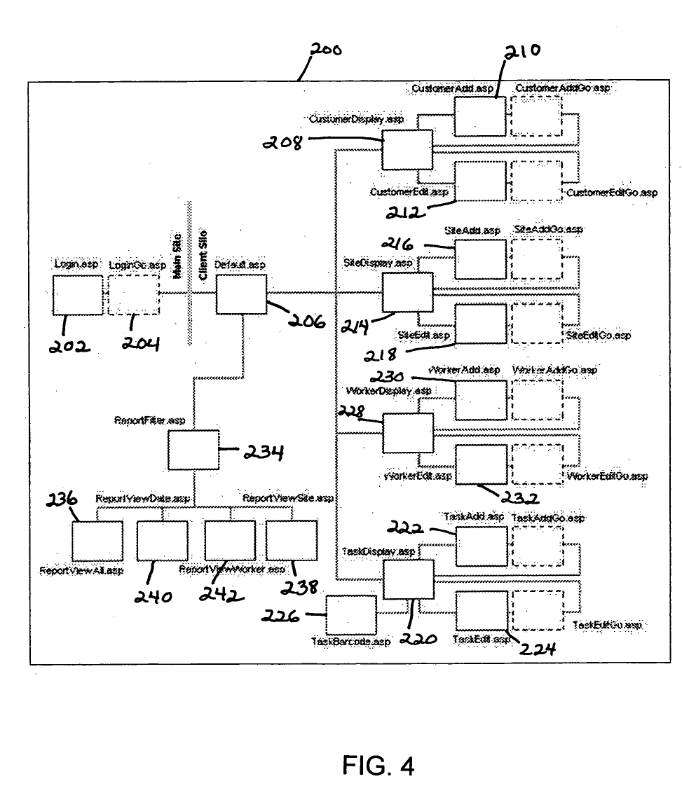

Referring to FIG. 4, a site outline for the application program 200 installed on the server of FIG. 3 is shown in a block diagram. In the description that follows, customers are distinguished from clients. That is, the application program 200 of FIG. 4 provides clients with the means to track how their workers provide services to customers. Thus, each client may be in the business of providing services to many customers. As shown in FIG. 4, the first step for a client is to log in as shown in the login screen 202.

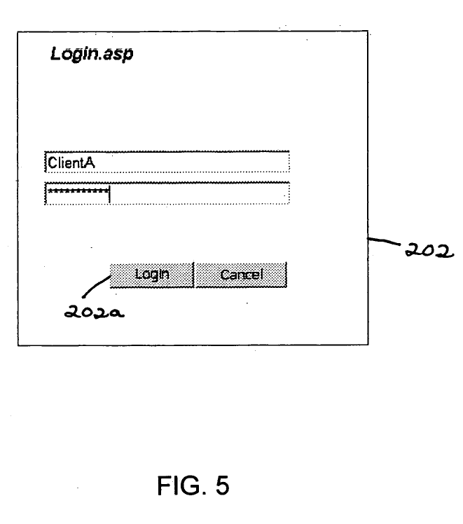

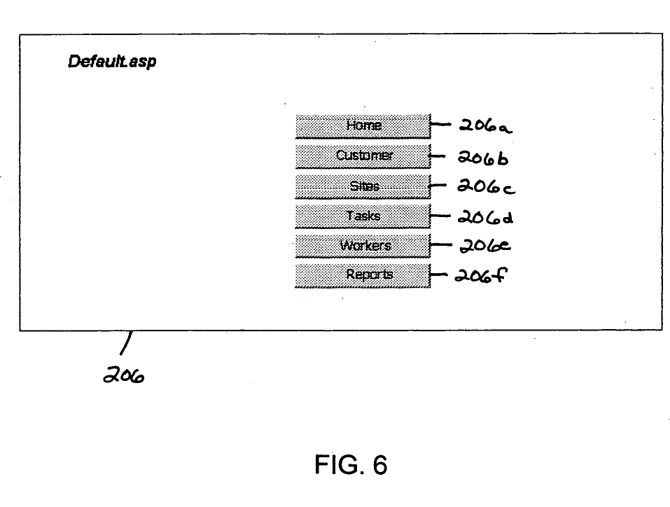

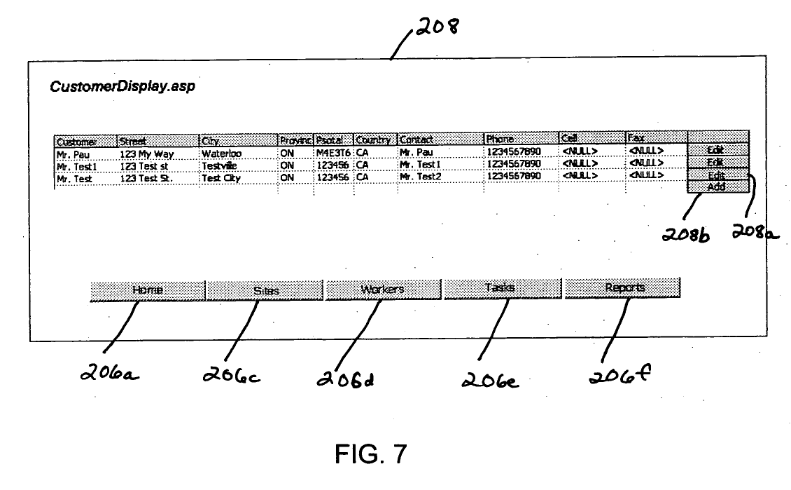

Referring to FIG. 5, the login screen 202 is shown as a screen capture. As shown in FIG. 5, a client will first identify itself—in the case of FIG. 5 as “client A”, and then enter a password that is unique to that client. As shown in FIG. 5, this password is not displayed on the screen. Then, the client will click the login bar 202a, and the server in step 204 checks to make sure that the login information is correct for client A. If the login information is correct for client A, then the server admits the client into a secure silo for that client and screen 206, shown in FIG. 6, provides the client with choices on how to proceed. That is, screen 206 includes a home bar 206a, a customer bar 206b, a sites bar 206c, a tasks bar 206d, a workers bar 206e and a reports bar 206f as shown in FIG. 3. If, for example, the client clicks on the customer bar 206b, then, as shown in FIG. 4, the application program 200 proceeds to screen 208, shown in FIG. 7.

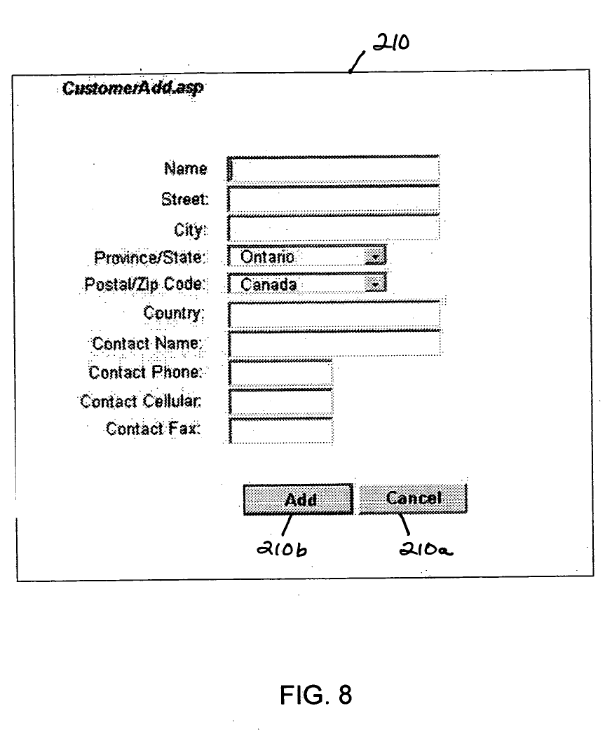

As shown in FIG. 7, the customer display screen 208 includes, for a particular client, the name of each customer of that client, the location of the customer and contact information for the customer. The customer display screen 208 also includes the home bar 206a, sites bar 206c, workers bar 206d, tasks bar 206e and reports bar 206f. By clicking on home bar 206a, the client can return to screen 206. On the rightmost end of the customer information, there is an edit bar 208a for each customer. Beneath these edit bars 208a, there is an add bar 208b. By clicking on the add bar 208b, the client is brought to screen 210 shown in FIG. 8.

In the add customer screen 210, the client is provided with fields in which to enter information regarding new customers to be added to the list of customers shown on screen 208. After adding this information, the client can either cancel the information entered by clicking cancel bar 210a, in which case all of the information entered is erased, or add this information to the client information shown in screen 208, by clicking add bar 210b, in which case the program 200 returns to screen 208, which now displays the newly added information.

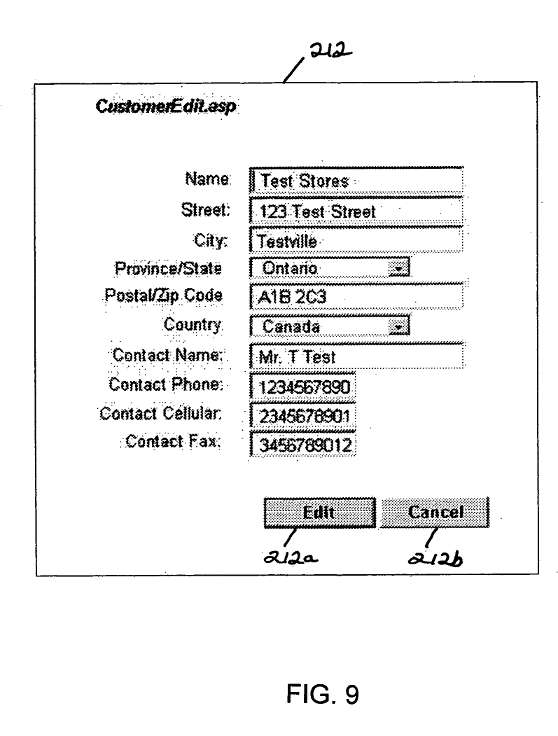

Referring back to FIG. 7, the client can choose to edit one of the customer entries by clicking the edit bar 208a in the row for that customer. In that event, screen 212 appears as shown in FIG. 9. Information for the particular customer is shown in screen 212 in an editable form such that the client can change whatever information requires updating. Then, this information can be either added to the customer information shown in screen 208 by clicking the edit bar 212a, or the edits can be cancelled by clicking cancel bar 212b.

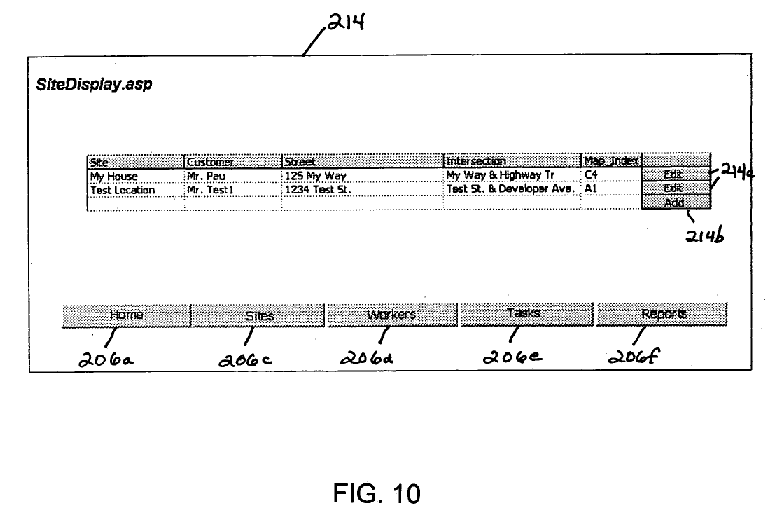

If the sites bar 206c is clicked by a client in either screen 206 of FIG. 6 or screen 208 of FIG. 7, then a site display screen 214, as shown in FIG. 10, will appear. This site display screen 214 provides a list of all of the sites for that client. Additionally, home bar 206a, sites bar 206c, workers bar 206d, tasks bar 206e and reports bar 206f are provided at the bottom of the screen 214, while edit bars 214a are provided to the right of each site entry, and an add bar 214b is provided to the right and below the edit bars 214a.

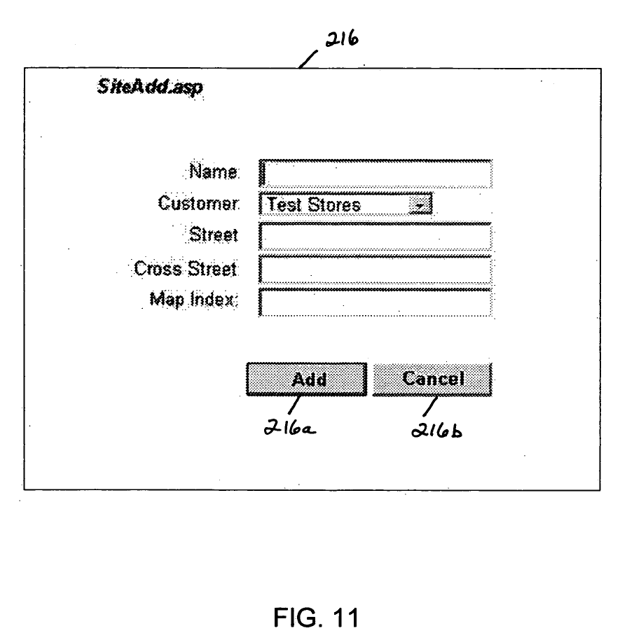

By clicking on the add bar 214b, the client is brought to an add site screen at 216 as shown in FIG. 11. In the add site screen 216, the client is provided with fields in which to enter information regarding new sites to be added to the list of sites shown on screen 214 of FIG. 10. After adding this information, the client can either cancel the entry by clicking the cancel bar 216b, in which case all of the information entered is erased, or add this information to the client information shown in screen 214 by clicking the add bar 216a, in which case the program 200 returns to screen 214, which now displays the newly added information.

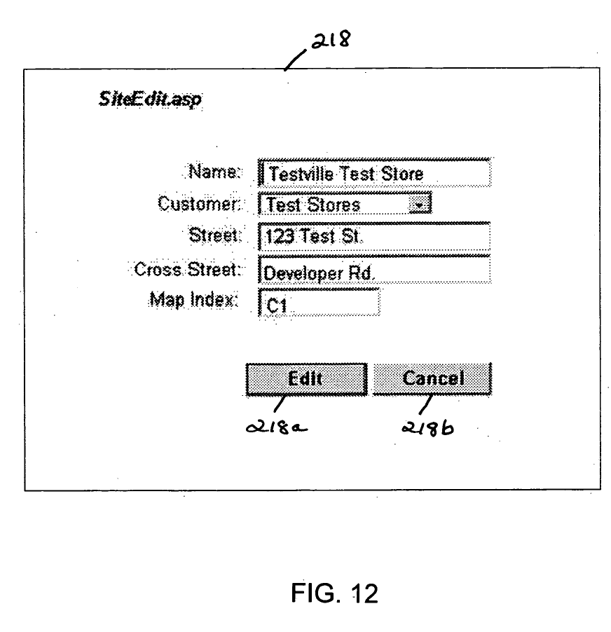

At screen 214 of FIG. 10, the client may also choose to edit one of the site entries by clicking the edit bar 214a in the row for that site. In that event, screen 218 appears as shown in FIG. 12. Information for the particular site is shown in screen 218 in an editable form such that a user (the client) can change whatever information requires updating. Then, the client can either cancel the edits by clicking the cancel bar 218b, or add the edits to the site information shown in screen 214 of FIG. 10 by clicking an edit bar 218a.

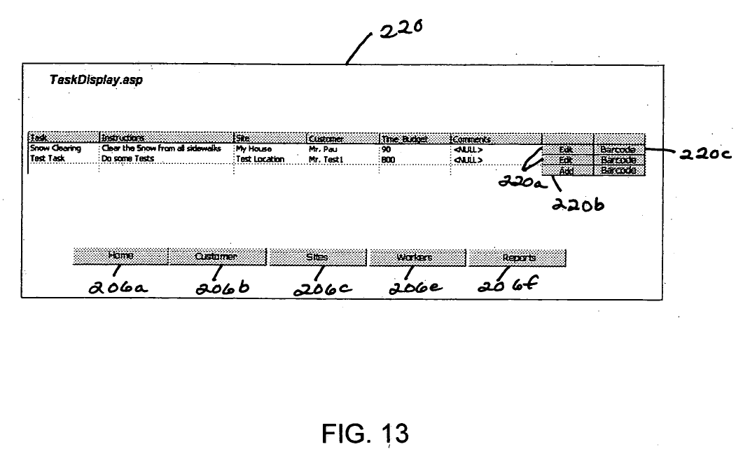

Referring back to screen 214 of FIG. 10, the client may move to tasks display screen 220, shown in FIG. 13, by clicking on the tasks bar 216. The tasks display screen 220 provides a list of all tasks to be performed for a particular client, as well as instructions on how those tasks are to be performed, the locations at which they are to be performed, the name of the customer, and the budgeted amount of time. At the right end of each row, an edit bar 220a, and barcode bar 220c are provided for the task associated with that row. Beneath the edit bars 220a an add bar 220b is provided.

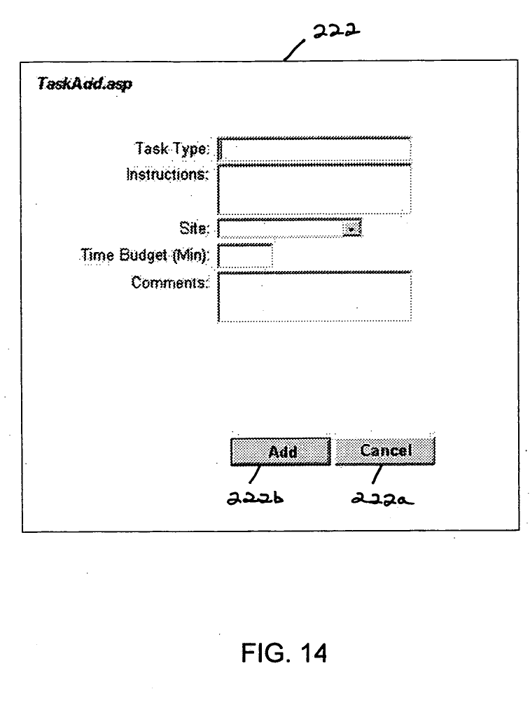

By clicking on the add bar 220b, the client is brought to screen 222 shown in FIG. 14. In the add task screen 222, the client is provided with fields in which to enter information regarding new tasks to be added to the list of tasks shown on screen 220. After adding this information, the client can either cancel the entry by clicking cancel bar 222a, in which case all of the information entered is erased, or add this information to the task information shown in screen 220, by clicking add bar 222b, in which case the program 200 returns to screen 220, which now displays the newly added information.

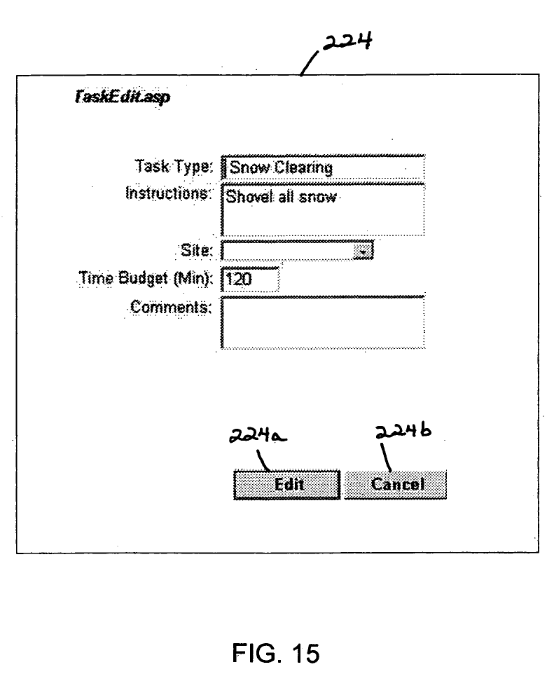

Referring back to screen 220 of FIG. 13, the client can choose to edit one of the task entries by clicking the edit bar 220a in the row for that task. In that event, the program 200 goes to screen 224 as shown in FIG. 15. Information for the particular task is shown in screen 224 in an editable form such that the client can change whatever information requires updating. Then this information can either be added to the task information shown in screen 220 by clicking edit bar 224a, or the edits can be cancelled by clicking cancel bar 224b.

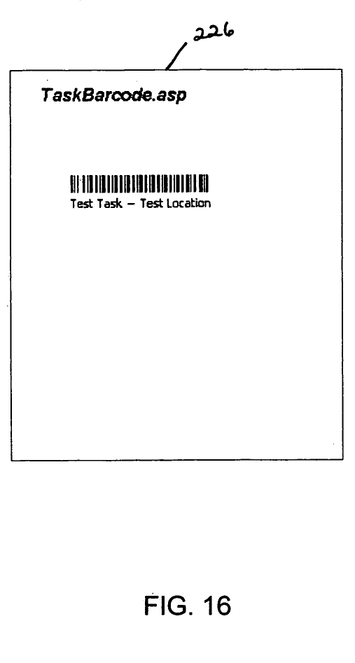

Referring back to screen 220 of FIG. 13, the client may also choose to view barcode information for a particular task by clicking the corresponding barcode bar for that task—i.e. the barcode bar in the row of that task. In that event, program 200 proceeds to screen 226 of FIG. 16, which displays the barcode for that task. Where a new site has been added at the screen 216 of FIG. 11, or a new task has been added at screen 222 of FIG. 14, a barcode for this new task or site can be generated by clicking the corresponding barcode bar for that task or site. In that event, program 200 automatically generates a new barcode designating that task or site, and then proceeds to screen 226, which displays the new barcode. These new barcodes can then be printed off the website. The barcode is carefully encoded to reduce the likelihood of people scanning random barcodes to disrupt the system. That is, the barcode can only readily be generated by the system itself, so that workers cannot generate their own barcode, and then use these barcodes to indicate that they have visited locations they have not in fact visited.

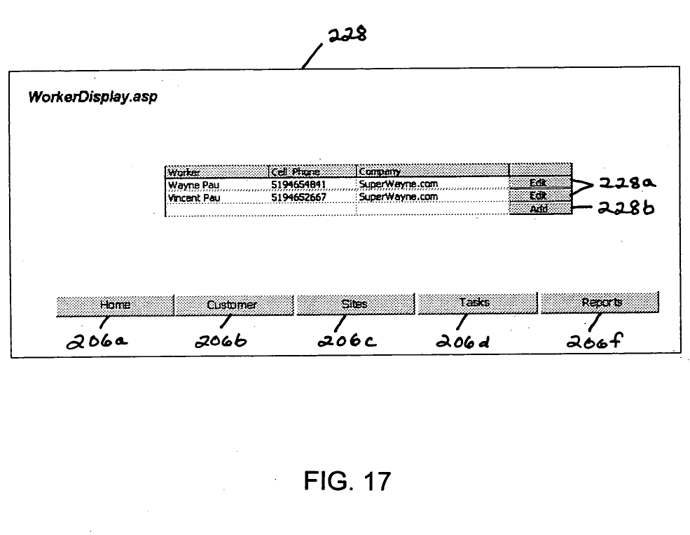

If the workers bar 206e is clicked by a client in screen 206 of FIG. 6, screen 208 of FIG. 7, screen 214 of FIG. 10, or screen 220 of FIG. 13, then program 200 goes to worker display screen 228 as shown in FIG. 17. The worker display screen 228 provides a list of all of the workers for a particular client. Contact information is also provided for each worker. To the right of this worker information, an edit bar 228a for each worker is provided, as well as an add bar 228b underneath the edit bar 228a.

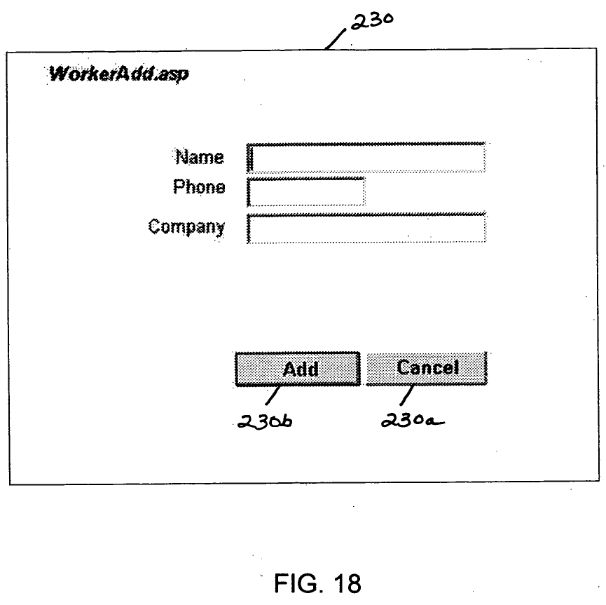

By clicking on the add bar 228b, the client is brought to an add worker screen at 230 as shown in FIG. 18. In the add worker screen 230, the client is provided with fields in which to enter information regarding new workers to be added to the list of workers shown on screen 228. After adding this information, the client can either cancel the entry, by clicking cancel bar 230a, in which case all of the information entered is erased, or add this information to the worker information shown in screen 230 by clicking add bar 230b, in which case the program 200 returns to screen 228, which now displays the newly added information.

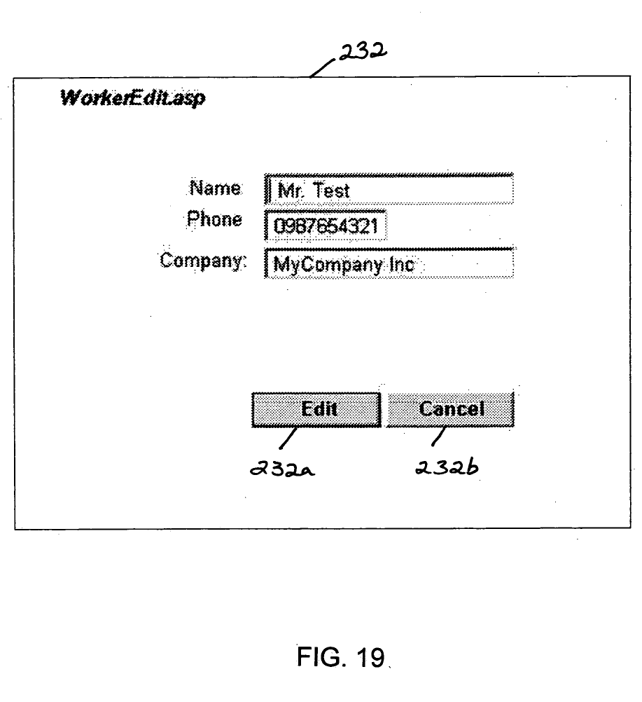

Referring back to FIG. 17, the client can choose to edit one of the worker entries by clicking the edit bar 228a in the row for that worker. In that event, edit worker screen 232 as shown in FIG. 19 appears. Information for the particular worker, is shown in screen 232 in an editable form, such that the client can change whatever information requires updating. Then, this information can be either added to the customer information shown in screen 208 by clicking edit bar 232a, or the edits can be cancelled by clicking cancel bar 232b.

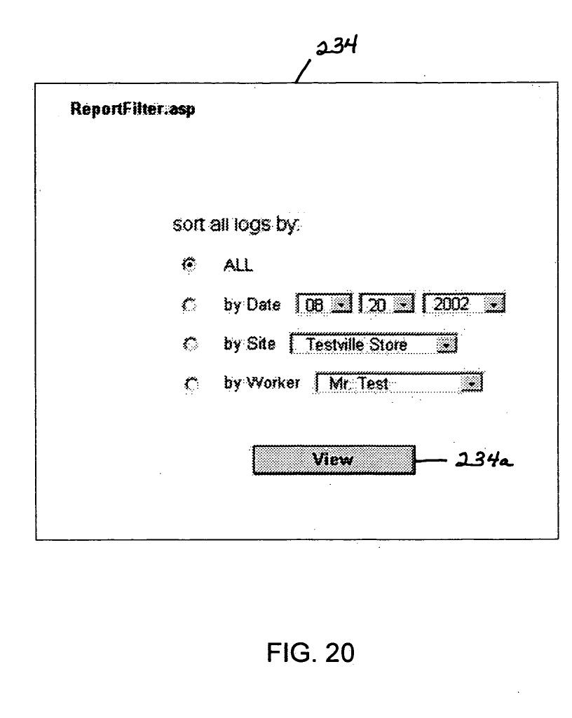

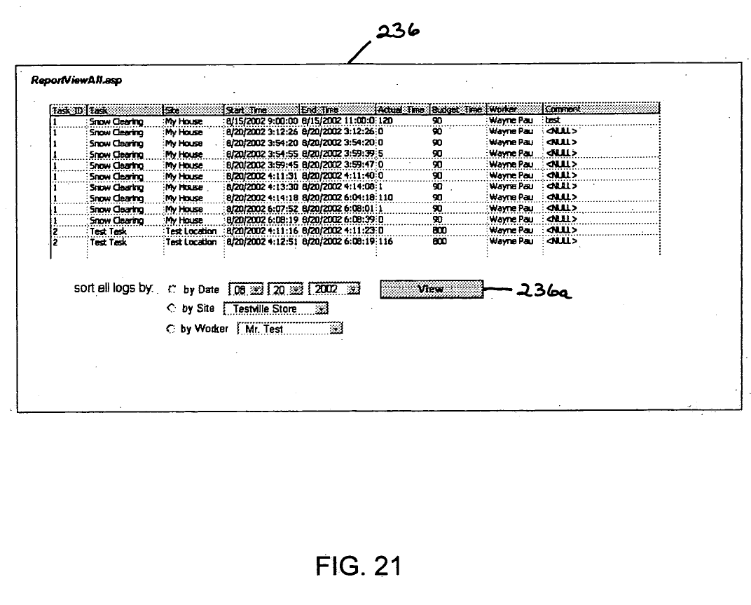

From any of screens 206, 208, 214, 220 and 228, the client may click on reports bar 206f, after which the program 200 will go to report filter screen 234 as shown in FIG. 20. As shown in screen 234, the client may choose to look at all of the service information data entered, or may choose to filter this information by date, by site or by worker. In screen 234, the client has chosen to look at all the service information data—that is, at all of the logs. Then, by clicking on the view bar 234a, the program 200 will move to screen 236 shown in FIG. 21.

Referring to FIG. 21, a screen 236 showing all of the service information data entered into the system for a particular client is shown. This information includes the task, the site, the start time, the end time, the actual time spent at the location, the worker and any comments made. Also, after viewing this information, the client can choose to filter this information by date, by site or by worker.

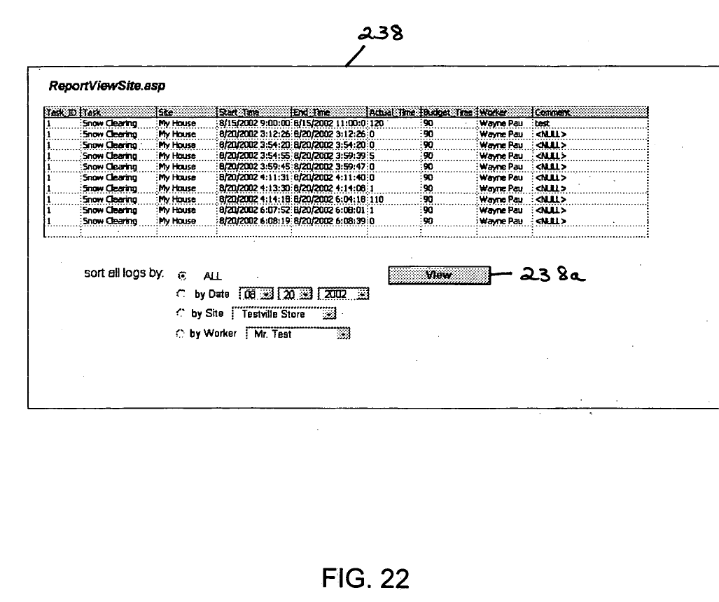

Say that the client chooses to sort all of the service information data shown in screen 236 by site, and specifies the site being filtered for as “My House”. Then, the client clicks view bar 236. The program 200 will then show screen 238 of FIG. 22.

In screen 238, service information data is provided for all tasks performed at the site “My House”—other locations being excluded. Thus, the information in screen 238 is the same as in screen 236, except that the service information data pertaining to the “test location” site has been excluded. Again, as with screen 236, the client can choose to further filter the search reports by date, by worker or by using a different site and then clicking on the view button 238a.

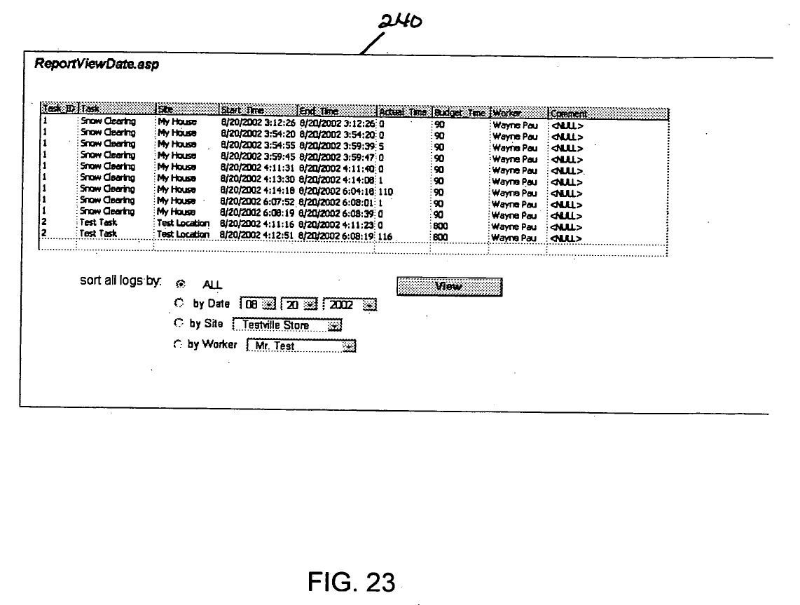

Referring back to screen 236, say that a client, instead of opting to further filter the search by site, decided to limit the search only to work done on Aug. 20, 2002. Then, the client had clicked on view bar 236a. The program 200 would then show the client screen 240 of FIG. 23, in which only service information data for Aug. 20, 2002 is included.

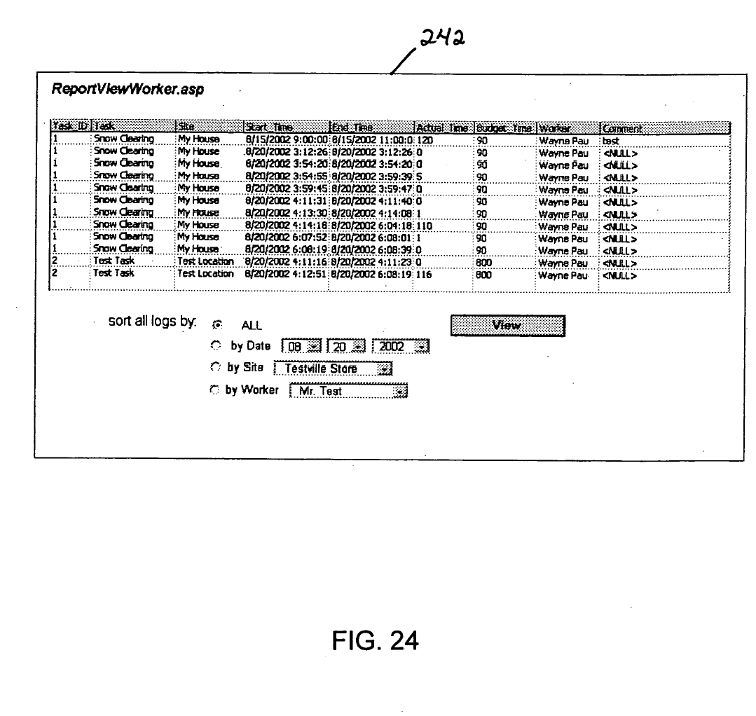

Say, instead, that at screen 234, the client had opted to search by worker, specifying Wayne Pau. Then, the program 200 would display screen 242 of FIG. 24 showing all of the service information data pertaining to tasks performed by Wayne Pau regardless of the location at which they were performed and the date on which they were performed.

Other variations and modifications of the invention are possible. For example, instead of bar codes being used to mark specific sites, RFID tags could be provided to each location, and tag interrogators to individual workers to read the RFID tags for locations visited. Alternatively, instead of using a cell phone, a scanner with a code-division multiple access (CDMA) radio may be used so that the scanner itself can be connected to the cellular network without any need for a cell phone. Of course, any suitable encoding methods, such as global systems for mobile-communications (GSM) or general packet radio service (GPRS). Further, according to preferred aspects of the invention described above, each barcode of a location expresses a unique code designating that location. However, while this is preferred, it is not absolutely necessary. Instead, the barcodes provided at a particular location may designate only the tasks to be performed at that location, and not the location itself. However, as described above in connection with FIGS. 13 and 14, location information for each task, and more specifically for each task barcode, is stored on the central server. Thus, location information can be determined simply by reading a task barcode, and then determining from the central server, the location at which that task is to be performed. As a result, according to aspects of the invention in which individual task barcodes designate a task only and do not include a location code identifying the particular location at which the task is to be performed, each of the task barcodes may, itself, be considered to encode a location identification code. Thus, according to this aspect of the invention, there may be more than one location code for a particular location—that is, each task code may also be considered to be a location code as a specific location is determinable from this task code information and from the central server. All such modifications are variations are believed to be within the sphere and scope of the invention as defined by the claims appended hereto.

1. A method of tracking time spent at a location by a person, the method comprising:
(a) providing at least one machine-readable location identification code at the location to provide location information for the location;
(b) providing the person with a reader for reading the at least one machine-readable location identification code at the location;
(c) on arrival of the person at the location, reading a first-read machine-readable location identification code in the at least one machine-readable location identification code using the reader and determining departure time based on when the first-read machine-readable location identification code is read;
(d) on departure of the person from the location, reading a last-read machine-readable location identification code in the at last one machine-readable location identification code using the reader and determining an arrival time based on when the last-read machine-readable location identification code is read; and,
(e) recording service information data comprising the arrival time and the departure time.

2. The method as defined in claim 1 wherein
step (a) comprises providing a plurality of machine-readable location identification codes distributed throughout a plurality of locations wherein for each location in the plurality of locations, the plurality of machine-readable location identification codes includes at least one associated machine-readable location identification code provided at the location for providing location information for the location; and,
step (d) further comprises recording the location information such that service information data further comprises the location information.

3. The method as defined in claim 2 further comprising identifying the person, wherein step (e) further comprises storing identification information for the person such that the service information data further comprises the identification information for the person.

4. The method as defined in claim 3 wherein the service information data is searchable by search parameters comprising at least one of the identification information for the person, the location information and a selected time interval including at least one of the arrival time and the departure time.

5. The method as defined in claim 4 further comprising selectably providing at least one of
a shift report for the person over a selected time interval, wherein the shift report comprises each location in the plurality of locations the person has visited during the selected time interval and, for each location, an associated time period spent at the location; and,
a location report for the location over a selected time interval, wherein the location report comprises each person that has visited the location during the selected time interval and a time spent by that person at the location.

6. The method as defined in claim 1 wherein
step (a) comprises providing at least one machine-readable task identifier at the location, wherein an associated machine-readable location identification code and associated task identification information are determinable from the at least one machine-readable task identifier, the associated machine-readable location identification code being included in the at least one machine-readable location identification code;
step (c) comprises reading the first-read machine-readable location identification code from a first-read machine-readable task identifier in the at least one machine-readable task identifier on arrival of the person at the location;
step (d) comprises reading the last-read machine-readable location identification code from a last-read machine-readable task identifier in the at least one machine-readable task identifier on departure of the person from the location; and,
the service information data comprises the associated task identification information for each machine-readable task identifier in the at least one machine-readable task identifier at the location.

7. The method as defined in claim 6 wherein the at least one machine-readable task identifier at the location comprises a plurality of machine-readable task identifiers at the location;
step (c) comprises
(i) reading the first-read machine-readable location identification code from a first machine-readable task identifier in the plurality of machine-readable task identifiers on arrival of the person at the location, and,
(ii) reading a subsequent machine-readable task identifier in the plurality of machine-readable task identifiers on commencing an associated task identified by the associated task information readable from the subsequent machine-readable task identifier;
the service information comprises, for each machine-readable task identifier in the plurality of machine-readable task identifiers, the associated task information, an associated task start time and an associated task completion time.

8. The method as defined in claim 1 wherein the reader comprises a wireless transmitter, and step (d) comprises transmitting the arrival time and the departure time from the reader to a storage device.

9. The method as defined in claim 1 wherein the reader comprises
a time-keeper for determining the arrival time and the departure time; and
a memory for storing the arrival time and the departure time, such that step (d) comprises storing the service information data in the memory.

10. The method as defined in claim 9 further comprising uploading the service information data from the reader to a storage device.

11. The method as defined in claim 6 wherein the at least one machine-readable task identifier comprises at least one barcode.

12. The method as defined in claim 1 wherein the at least one machine-readable location identification code comprises a single code only such that the first-read machine-readable location identification code and the last-read machine-readable location identification code are identical.

13. A system for tracking time spent at a location by a person, the system comprising:
at least one machine-readable location identification code provided at the location to provide location information for the location;
a mobile reader for reading the at least one machine-readable location identification code at the location;
a time keeper for determining an arrival time when a first-read machine-readable location identification code in the at least one machine-readable location identification code is read and a departure time when a last-read machine-readable location identification code in the at least one machine-readable location identification code is read; and
a storage medium for recording service information data comprising the arrival time and the departure time.

14. The system as defined in claim 13 further comprising a plurality of machine-readable location identification codes distributed throughout a plurality of locations wherein for each location in the plurality of locations, the plurality of machine-readable location identification codes includes an associated at least one machine-readable location identification code provided at the location for providing location information for the location, wherein the service information data further comprises the location information, and the storage medium is operable to store the location information.

15. The system as defined in claim 14 further comprising personal identification means for providing identification information for the person, wherein the service information data further comprises the identification information, and the storage medium is operable to store identification information.

16. The system as defined in claim 15 further comprising a searching module for searching the service information data using search parameters including at least one of the identification information for the person, the location information and a selected time interval including at least one of the arrival time and the departure time.

17. The system as defined in claim 16 further comprising a report generation means for generating at least one of
a shift report for the person over a selected time interval, wherein the shift report comprises each location in the plurality of locations the person has visited during the selected time interval and, for each location, an associated time period spent at the location; and,
a location report for the location over a selected time interval, wherein the location report comprises each person that has visited the location during the selected time interval and a time spent by that person at the location.

18. The system as defined in claim 13 wherein
the at least one machine-readable location identification code is provided by at least one machine-readable task identifier at the location;
the mobile reader is operable to read the at least one machine-readable location identification code and associated task identification information from the at least one machine-readable task identifier; and
the service information data comprises the associated task identification information for each machine-readable task identifier in the at least one machine-readable task identifier at the location.

19. The system as defined in claim 18 wherein
the at least one machine-readable task identifier at the location comprises a plurality of machine-readable task identifiers at the location;
the time-keeper is operable to determine
(i) the arrival time to be when the first-read machine-readable location identification code is first read from a first machine-readable task identifier in the plurality of machine-readable task identifiers,
(ii) an associated task start time for each machine-readable task identifier to be when the machine-readable task identifier is first read, and
(iii) an associated task completion time for each machine-readable task identifier to be at least one of when, after the machine-readable task identifier is first read, the machine-readable task identifier is next read and another machine-readable task identifier is read; and,
the service information comprises, for each machine-readable task identifier in the plurality of machine-readable task identifiers, the associated task information, an associated task start time and an associated task completion time.

20. The system as defined in claim 13 wherein the reader comprises a wireless transmitter for transmitting the arrival time and the departure time from the reader to a storage device.

21. The system as defined in claim 13 wherein the reader comprises a time-keeper for determining the arrival time and the departure time; and, a memory for storing the arrival time and the departure time.

22. The system as defined in claim 21 further comprising connection means for uploading the service information data from the reader to a storage device.

23. The system as defined in claim 18 wherein the at least one machine-readable task identifier is at least one barcode.

24. The system as defined in claim 13 wherein the at least one machine-readable location identification code comprises a single code only, such that the first-read machine-readable location identification code and the last-read machine-readable location core are identical.

25. A computer program product for use on a computer system to track the time spent at a location by a person, the computer program product comprising:
a recording medium; and
means recorded on the medium for instructing the computer system to perform the steps of:
receiving service information data from a person, the service information data comprising at least one pair of matching entries, the at least one pair of matching entries comprising an arrival entry and a departure entry, the arrival entry comprising a first-read location code and the departure entry comprising a second-read location code,
determining the location based on the first-read location code and the second-read location code;
determining an arrival time from the arrival entry; and,
determining a departure time from the departure entry.

26. The computer program product as defined in claim 25 wherein the arrival entry comprises an arrival time record recording the arrival time, and the departure entry comprises a departure time record recording the departure time.

27. The computer program product as defined in claim 25 wherein the service information data comprises identification information for the person, the means recorded on the medium being further operable to instruct the computer system to provide a report generation means for generating at least one of
a shift report for the person over a selected time interval, wherein the shift report comprises each location in the plurality of locations the person has visited during the selected time interval and, for each location, an associated time period spent at the location; and,
a location report for the location over a selected time interval, wherein the location report comprises each person that has visited the location during the selected time interval and a time spent by that person at the location.
